(19) United States
(12) Patent Application Publication
(10) Pub. No.: US 2005/0242528 A1
(43) Pub. Date: Nov. 3, 2005

(54) Seal assembly with dual density powder metal seat member

(76) Inventor: Vincent A. Nikonchuk, Hebron, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(21) Appl. No.: 10/837,010

(22) Filed: Apr. 30, 2004

(51) Int. Cl. F16K 15/00

(52) U.S. Cl. 277/628

(57) ABSTRACT

A dual density powder metal mechanical face seal seat is provided including a hub portion integrally formed as a unitary piece with a seat portion. The face seal seat is formed of powder metal that has a higher density in the hub portion than in the seat portion. The higher density hub portion provides the seal seat with greater strength characteristics where the seal seat mounts to a shaft. The lower density seat portion allows greater amounts of lubrication to be impregnated in the seal seat portion where it is needed while a smaller amount of lubrication is provided in the hub portion where it is not needed. The higher density hub portion has a higher coefficient of thermal conductivity to draw heat away from the seal seat portion. The smaller pores in the hub portion provide a capillary effect to cause lubrication impregnated in the seal seat to be sucked back into the pores when the seal seat is not rotating. The duel density powder metal also eliminates the necessity to mask portions of the seal seat while the seal seat is being impregnated with lubrication since the dual density regions automatically control the impregnation amount in the different regions.

### FIELD OF THE INVENTION

The present invention relates to a fluid seal for use in sealing a rotating member and more particularly, to a mechanical face seal assembly.

### BACKGROUND AND SUMMARY OF THE INVENTION

Mechanical face seal assemblies are often used to provide a fluid seal between a housing member and a shaft, one of which is rotating with respect to the other. Typically, the housing is stationary and the shaft is rotating. The mechanical face seal prevents fluid loss for between the shaft and the housing.

A mechanical face seal assembly normally includes a seal ring or washer and a mating seal seat. The seal seat is mounted such that it rotates with the shaft while the seal washer remains stationary. The seal washer is axially loaded; i.e., a spring or other force transmitting member urges the seal washer in the axial direction of the shaft. The axially transmitted force urges the seal washer into engagement with the seal seat to provide the fluid seal. Seal assemblies of this type are known as dynamic seals in that one of the seal elements, in this case the seal washer, moves axially with respect to a corresponding seal seat. In typical mechanical face seals, the seal seat member is in a form of an annular ring and does not serve any other purposes other than to act as the mating surface against the seal washer.

According to the present invention, the seal seat is provided with an additional hub portion to which other components can be mounted for rotation with the shaft. For example, for mechanical face seals used in a dishwasher, other rotatably driven members such as particle cutters, pump impellers, or other rotatable members as is known in the art can be mounted to the hub portion. The seal seat member is made from powder metal with different densities in the hub portion and seal seat portion. The hub portion is provided with a higher density than the seal seat portion in order to provide the hub portion with better structural characteristics, such as hardness, impact strength, improved yield stress and crush strength. The lower density in the seal seat region allows for higher levels of lubrication to be impregnated in the seal seat portion while allowing minimal lubrication impregnation in the hub portion. The higher density hub portion also has a higher coefficient of thermal conductivity than the seat. The higher density hub portion takes heat away from the seal seat portion to prevent the seal seat portion from wearing prematurely.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of a mechanical face seal assembly incorporating a dual density powder metal face seal seat according to the principles of the present invention;

FIG. 2a is a perspective view of an exemplary face seal seat according to the principles of the present invention;

FIG. 2b is a top plan view of the seal seat shown in FIG. 2a;

FIG. 2c is a bottom plan view of the seal seat shown in FIG. 2a; and

FIG. 2d is a cross-sectional view taken along line D-D of FIG. 2b.

### DETAILED DESCRIPTION OF THE PREFERRED EMBODIMENTS

The following description of the preferred embodiment(s) is merely exemplary in nature and is in no way intended to limit the invention, its application, or uses.

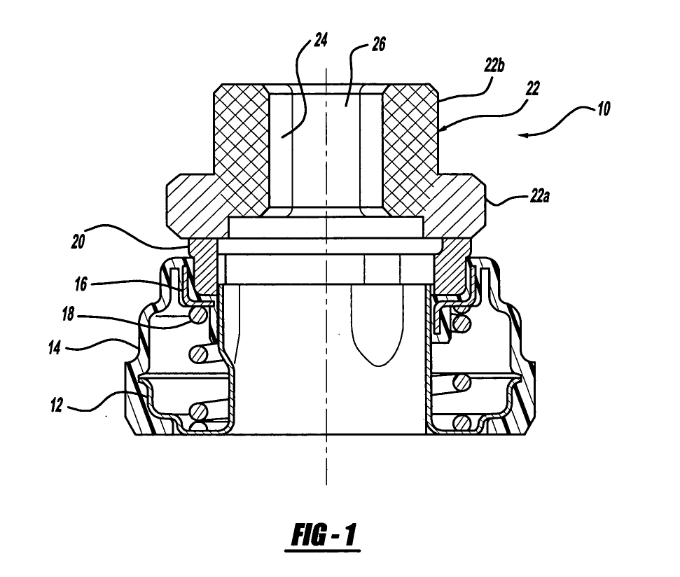

With reference to FIG. 1, an exemplary face seal assembly will now be described in which the dual density powder metal face seal seat, according to the principles of the present invention, is incorporated. The mechanical face seal 10 includes an annular spring seat 12 formed of sheet metal. A flexible boot 14 formed of an elastomeric material is attached to the spring seat 12 at a first end and includes a reinforcing insert ring 16 at a second end thereof. A coil spring 18 is disposed between the spring seat 12 and the second end of the boot 14 for applying a biasing force against the insert 16. A seal washer 20 is disposed against the second end of the boot 14 and is formed as an annular ring. A seal seat member 22 includes a seal seat portion 22a and a hub portion 22b. The seal seat portion 22a is disposed against the seal washer 20 and the hub portion 22b is adapted to be mounted to a motor driven shaft.

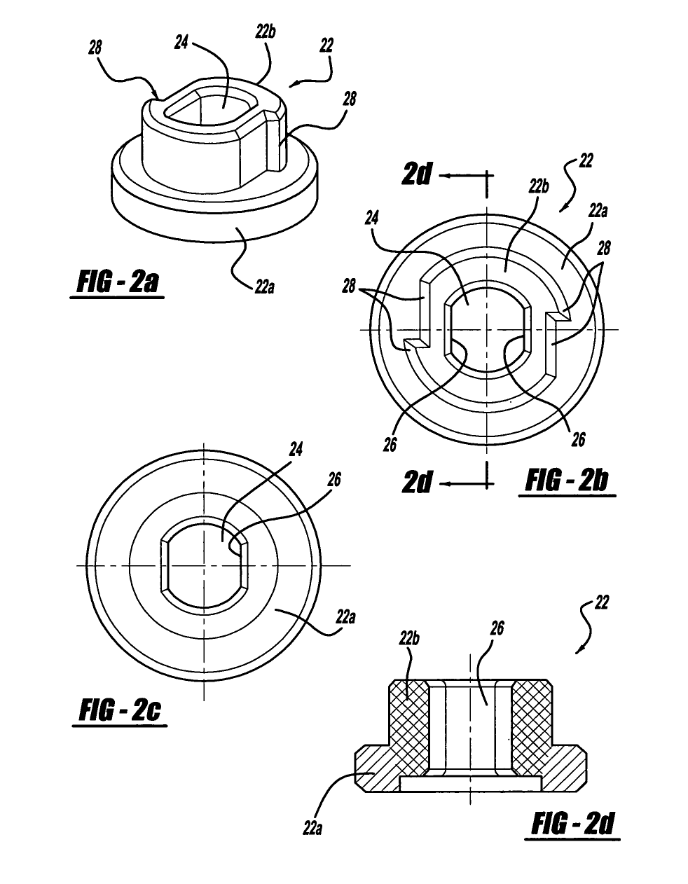

The hub portion 22b includes a centrally disposed aperture 24 having a pair of flats 26 which non-rotatably engage a shaft inserted therethrough (not shown). The hub portion 22a is also provided with external mounting features 28 (best shown in FIGS. 2a and 2b) such as flats and/or tabs to which rotatable components can be mounted. By way of example, a pump impeller or particle cutter of a dishwasher can be mounted to the hub portion 22a of the seal seat member 22 and thereby eliminate the need for additional components for rotatably mounting these items.

The seal seat member 22 is formed of powder metal with the hub portion 22b being formed integrally with the seal seat portion 22a as a unitary piece. The density of the powder metal in the hub portion is higher than the density of the powder metal in the seat portion 22a as illustrated by the cross-hatched portion in the hub portion 22b. The greater density in the hub portion 22b allows for better structural characteristics, such as hardness, impact strength, improved yield stress, and crushed strength. The better structural characteristics in the hub portion 22b is desirable since it connects the mechanical face seal seat to the shaft, and must have different characteristics than the seal seat portion 22a. The higher density hub portion 22b also has a higher coefficient of thermal conductivity than the seat portion 22a. Thus, the hub portion 22b takes heat away from the seal seat 22a to prevent the seal seat 22a from heating up and wearing prematurely.

The design of the present invention allows for various levels of impregnation within the seal seat member 22 so that presently used vacuum impregnation systems can be used without the need to mask certain portions of the mechanical face seal seat. This allows the impregnation of lubrication to be maximum on the mechanical face seal seat contact area and minimal in the hub area 22b where it is not needed. The various levels of impregnation that are obtainable reduces the amount of impregnation that slings off of the part since less impregnation is needed and the higher density hub portion has smaller pores. The smaller pores create a capillary effect, and when the mechanical face seal seat and hub is not spinning, and no heat is being generated, the impregnation is sucked back into the hub portion 22b and the seal seat portion 22a and off of the contact area surface through the capillary action such that there is less impregnation material left on the mechanical face seal seat to be slung off. This may also decrease the amount of torque required at initial start-up since less impregnation material on the mechanical face seal seat will reduce the amount of bond between the mechanical seal seat face and the mechanical seal washer face 20.

The description of the invention is merely exemplary in nature and, thus, variations that do not depart from the gist of the invention are intended to be within the scope of the invention. Such variations are not to be regarded as a departure from the spirit and scope of the invention.

1. A seal seat member, comprising:
an annular seal seat portion;
a seal hub portion integrally formed as a unitary piece with said seal seat portion, said seal seat portion and said seal hub portion each being made from powder metal, a density of said powder metal in said seal hub portion being greater than a density of said powder metal in said seal seat portion.

2. The seal seat member according to claim 1, wherein said seal seat portion and said seal hub portion are impregnated with lubrication, said seal seat portion having a greater amount of impregnation than said seal hub portion.

3. The seal seat member according to claim 1, wherein said seal seat portion is generally ring shaped.

4. The seal seat member according to claim 1, wherein said seal hub portion has at least one flat portion on an inner surface thereof.

5. A face seal, comprising:
a spring set portion;
a flexible boot attached to said spring seat portion at a first end and including a reinforcing insert ring at a second end;
a spring disposed between said spring seat portion and said reinforcing insert ring;
a seal washer disposed against said second end of said flexible boot; and
a seal seat member including an annular seal seat portion disposed against said seal washer, said seal seat member further including a seal hub portion integrally formed as a unitary piece with said seal seat portion, said seal seat portion and said seal hub portion each being made from powder metal, a density of said powder metal in said seal hub portion being greater than a density of said powder metal in said seal seat portion.

6. The face seal according to claim 5, wherein said seal seat portion and said seal hub portion are impregnated with lubrication, said seal seat portion having a greater amount of impregnation than said seal hub portion.

7. The face seal according to claim 5, wherein said seal seat portion is generally ring shaped.

8. The face seal according to claim 5, wherein said seal hub portion has at least one flat portion on an inner surface thereof.
